(19) United States
(12) Patent Application Publication
(10) Pub. No.: US 2019/0171732 A1
(43) Pub. Date: Jun. 6, 2019

(54) SYSTEMS AND METHODS FOR EVALUATING ACCURACY OF PLACE DATA BASED ON CONTEXT

(71) Applicant: Uber Technologies, Inc., San Francisco, CA (US)

(72) Inventors: Livia Zarnescu Yanez, Menlo Park, CA (US); Shivendra Pratap Singh, Redwood City, CA (US); Chandan Sheth, San Francisco, CA (US); Alvin AuYounG, San Jose, CA (US); Sheng Yang, Fremont, CA (US); Vikram Saxena, Cupertino, CA (US)

(21) Appl. No.: 15/829,573

(22) Filed: Dec. 1, 2017

(51) Int. Cl. G06F 17/30; G06N 99/00; G06N 7/00

(52) U.S. Cl. CPC G06F 17/30241; G06N 7/005; G06N 99/005; G06F 17/30371

(57) ABSTRACT

Various embodiments determine accuracy of place data by determining a context for a place record (that is included in the place data) and determining accuracy of the place record based on a set of criteria associated with the context determined for the place record. For some embodiments, the set of criteria is used in place of, or in conjunction with, another set of fixed criteria for determining accuracy of the place record. Context for the given place record may be determined based on a set of features for the given place record, and the set of features may be generated (e.g., derived or extracted) based on values of one or more attributes (e.g., record fields or fields) included in the given place record. For some embodiments, a quality of a place record is determined based on at least the determination of an accuracy of the place record.

### TECHNICAL FIELD

The described embodiments generally relate to map data and, more particularly, to systems, methods, and machines for evaluating, based on context, the accuracy of data regarding (e.g., that describes) one or more places on a geographic map.

### BACKGROUND

Beyond just address and road information, certain map-based services operate by using additional information regarding locations on a geographic map, such as whether a location on the geographic map is a place of business and, if so, whether the business is still open, what are its business hours, what type of business is it, whether the business is accessible from a public road, and whether the business is accessible by the public. Such additional information is usually included in, or provided as, place information. Map-based services, such as a ride service, a ride-sharing service, or a delivery service, may require place information for operation or may use place information to improve the quality of results, accuracy of results, or overall performance.

Unfortunately, the usefulness of place information can be highly dependent on its accuracy and relevance, place information accuracy can vary between different data sources providing place information, and place information relevance can depend on accuracy (e.g., inaccurate place information is not relevant for use). This is particularly true when a data source providing place information to the map-based service is maintained by a third party, or the place information data source is based on (e.g., populated or updated) by crowd sourcing.

### BRIEF DESCRIPTION OF THE DRAWINGS

Various ones of the appended drawings merely illustrate various embodiments of the present disclosure and cannot be considered as limiting its scope.

FIG. 1 is a block diagram illustrating an example networked computing environment 100 that includes a place data system, according to some embodiments.

FIG. 2 is a diagram illustrating the operation of an example accuracy determination system for determining accuracy of place data, according to some embodiments.

FIGS. 3-5 are flowcharts illustrating example methods for determining accuracy of place data, according to some embodiments.

FIG. 6 is a diagram illustrating example criteria for determining accuracy of place data, according to some embodiments.

FIG. 7 provides screenshots illustrating example ground-truth and place data-provided coordinates for given places, for which accuracy can be determined according to some embodiments.

FIG. 8 is a block diagram illustrating components of an example machine used to implement some embodiments.

The headings provided herein are merely for convenience and do not necessarily affect the scope or meaning of the terms used.

### DETAILED DESCRIPTION

The description that follows describes systems, methods, techniques, instruction sequences, and computing machine program products that illustrate various embodiments for evaluating accuracy of data (hereafter, “place data”) describing one or more places on a geographic map. More particularly, various embodiments described herein evaluate accuracy of geographic coordinates, for a place on a geographic map, provided by place data describing one or more places on a geographic map. For various embodiments described herein, place data is maintained as one or more place data records (hereafter, “place records”), where each place record can comprise data regarding a single place located on a geographic map (hereafter, “map”). According to some embodiments, a set of criteria for determining accuracy of place records comprises at least one criterion that causes the capture of place records that are sufficiently accurate for use by a particular service, such as a ride-sharing service or a delivery service.

For example, with respect to use by a ride or ride-sharing service, a given place record may describe a place on a map that a rider wants to go to, which can include, without limitation, an individual home (e.g., rider's home), a restaurant, a hotel or motel, a public transit station, an airport, a venue (e.g., for sports or concert), a clinic, a hospital, a gym, a retail store, and an office building. In this context, the set of criteria can include a criterion that ensures that place records include geographic coordinates accurate for purposes of a ride drop-off location or a pick-up location (e.g., entrance of a place described by a place record). For some embodiments, the set of criteria for determining accuracy of a given place record, which is to be used by a ride or ride-sharing service, comprises one or more of: a criterion that ensures that geographic coordinates from a place record for a place are not across the road from ground-truth coordinates for the same place; a criterion that the geographic coordinates from the place record are within a certain upper bound and lower bound distance from ground-truth coordinates; and a criterion that the geographic coordinates from the place record are within a certain distance from ground-truth coordinates based on a local urban density associated with the place and based on a category of the place (e.g., hospital, school, residence, shopping mall, etc.).

For some embodiments, where ground-truth coordinates are not available with respect to a given place record, the given place record is processed by a machine learning (ML) model using one or more features present in the given place record (e.g., place category or local density features) and use the ML models output to determine a confidence score for the given place record. The confidence score may represent a probability of the given place record meeting a set of quality criteria or not. For instance, a place record with a low score may be designated as “low confidence,” and the place record may either be filtered out as well or more information about the place record may be solicited (e.g., getting additional third-party evidence, or asking a user for feedback). A place record with a high score may be designated as “high confidence” and may be retained or updated.

Various embodiments can determine accuracy of place data by determining a context for a place record (that is included in the place data) and determining accuracy of the place record based on a set of criteria associated with the context determined for the place record. For some embodiments, this set of criteria is used in place of, or in conjunction with, another set of fixed criteria for determining accuracy of the place record. Context for the given place record may be determined based on a set of features for the given place record, and the set of features may be generated (e.g., derived or extracted) based on values of one or more attributes (e.g., record fields or fields) included in the given place record. For some embodiments, a quality of a place record is determined based on at least the determination of the accuracy of the place record. Though various embodiments are described herein with respect to determining the accuracy of a place record based on accuracy of geographic coordinates provided by the place record, some embodiments can determine accuracy of the place record based on accuracy of another attribute of the place record (e.g., name, address, category, etc.).

According to some embodiments, determining the accuracy of a given place record comprises determining the accuracy of geographic coordinates provided by the given place record for the place described by the given place record. In particular, some embodiments achieve this accuracy determination by comparing the geographic coordinates provided by the given place record to ground-truth coordinates (e.g., human-curated geographic coordinates) for the place described by the given place record. As used herein, ground-truth coordinates for a particular place can comprise curated latitude and longitude coordinates for the particular place, which may have been manually curated by a human individual. Ground-truth coordinates may comprise rooftop coordinates for the particular place and may correspond to a centroid or approximate centroid of the particular place. Ground-truth coordinates may comprise coordinates corresponding to a pick-up or drop-off location (e.g., a popular location) with respect to a ride or ride-sharing service. Additionally, a ground-truth coordinates may comprise coordinates corresponding to a building entrance or exit location.

With respect to determining accuracy of geographic coordinates from a given place record, examples of features generated for the given place record may include, without limitation: distance between ground-truth coordinates for the particular place and geographic coordinates from the given place record for the particular place (hereafter, also referred to as “dist_gt feature”); whether the geographic coordinates from the given place record and the ground-truth coordinates correspond to locations on a geographic map that are across a road (e.g., road geometry on the geographic map) from each other (hereafter, also referred to as “across-the-road (XTR) feature”); whether the geographic coordinates correspond to a location on the geographic map that is on or adjacent to a road (hereafter, also referred to as “on-the-road feature”); whether the geographic coordinates correspond to a location inside a building structure (hereafter, also referred to as “inside-building feature”); whether the geographic coordinates share a nearest same road segment with the ground-truth coordinates (hereafter, also referred to as “nearest-same-segment feature”); whether the geographic coordinates share a nearest popular road segment with the ground-truth coordinates (hereafter, also referred to as “nearest-popular-segment feature”); whether the geographic coordinates are in clear line-of-sight from a point of ingress or egress (e.g., point of entry) for the place; and whether the geographic coordinates are within geographic boundaries associated with the place. Other features generated for the given place record may include, without limitation; a median distance for a place category associated with the place (e.g., a matching median distance calculated from matched map features from third-party providers); a lot area associated with the place; a lot perimeter associated with the place; a density associated with the place (e.g., local S2 cell density); a cell count associated with the place; a check-in distance associated with the place; and a pick-up or drop-off distance associated with the place.

Some embodiments use a machine learning (ML) model, such as a decision tree model or a linear regression model, to determine which features of place records should be used in a set of criteria that determines accuracy of place records (e.g., accuracy of geographic coordinates from a place record). For example, the feature selection process may comprise iteratively building a ML model, tuning the ML model by selectively adding or removing features processed by the ML model, and evaluating the performance of the tuned ML model (e.g., evaluating how well the tuned ML model can predict accuracy of a place record based on the set of selected features being processed by the tuned ML model). Accordingly, an embodiment may determine performance of a tuned ML model by determining whether the set of selected features processed by the tuned ML model can accurately predict whether geographic coordinates provided by a place record are within a place's bounding region, where such a determination can serve as a proxy for accuracy of the geographic coordinates.

Bounding regions for places described by place records may be defined by human individuals, and the place records may be ones having ground-truth coordinates available. For some embodiments, when a tuned ML model exhibits acceptable or desired performance (e.g., prediction accuracy), a set of selected features currently being processed by the tuned ML model (e.g., across-the-road feature and a feature relating to distance threshold between geographic coordinates and ground-truth coordinates) are the ones used in a set of criteria for determining accuracy of a place record (e.g., determining accuracy of geographic coordinates of the place record).

Based on the context determined for a given place record, the set of criteria used to determine accuracy of geographic coordinates of the given place record can include, without limitation, a distance threshold with respect to the distance between ground-truth coordinates for the place described by the given place record and the geographic coordinates of the given place record. In this way, when determining accuracy of the geographic coordinates, various embodiments can define a context-based distance threshold for comparing the geographic coordinates, provided by the given place record for a place, to the ground-truth coordinates for the same place. For example, a context determined for a place record may indicate that the place record describes a place that occupies a large geographic area (hereafter, a large place) or a small geographic area (hereafter, a small place). Examples of places that may occupy a large geographic area may include, without limitation, a hospital, a large retail store, a shopping mall, a car dealership, an office complex, a school campus, an amusement park, or a golf course. Where the context indicates that the place record describes a large place, the set of criteria used to determine accuracy of geographic coordinates can be different from the set of criteria used to determine accuracy of geographic coordinates for a small place (e.g., an individual's house).

For instance, with respect to the difference in distance between ground-truth coordinates and geographic coordinates provided by place records, the set of criteria for large places may include a margin of error for the distance difference that is relaxed (e.g., 100 meters) in comparison to the margin of error used for smaller places (e.g., 50 meters). Accordingly, using a different set of criteria for a place record describing a large place can permit an embodiment to determine that geographic coordinates from the place record are accurate when the same geographic coordinates fails to satisfy a set of criteria for a small place. This may be particularly useful for determining accuracy of place records used with ride or ride-sharing services. For instance, using a different set of criteria determining accuracy of a place record describing a large place may be useful where geographic coordinates provided by a place record correspond to an acceptable drop-off or pick-up location with respect to a large place described by the place record (e.g., an ingress/egress point for the place or a location easily reachable by foot from the place) and where the geographic coordinates satisfy a set of criteria for a large place but the distance between the geographic coordinates and the ground-truth coordinates causes the geographic coordinates to fail to satisfy a set of criteria for a small place. With respect to determining accuracy of geographic coordinates that are provided by a place record that describe a small place, a desirable drop-off or pick-up location may be in front of the small place and, as such, may be evaluated for accuracy under a set of criteria for a small place, which may include a tighter threshold for distance between the geographic coordinates and the ground-truth coordinates than a set of criteria for a large place.

According to some embodiments, a set of context-based criteria comprises a criterion relating to whether ground-truth coordinates and geographic coordinates from a place record correspond to locations across a road from each other. For example, the criterion may specify that the corresponding locations cannot be across a road from each other. For some embodiments, a set of context-based criteria comprises a criterion relating a threshold for distance between locations corresponding to ground-truth coordinates and geographic coordinates from a place record. For example, the distance threshold may be defined by a static value, may be calculated based on a median distance associated with a place category (e.g., median between place records matched between different data sources) where such median distance is available, calculated based on average distance between places in the locality (cell) corresponding to the geographic coordinates of the place record (e.g., density in the S2 cell) where such average distance is available, or some combination thereof.

Various embodiments described herein can improve the ability of a computer system to determine accuracy of place data that describes a place on a geographic map. Additionally, various embodiments described herein can assist in building a comprehensive database of accurate place data, which may be utilized to accurately describe potential destinations for a location-based service, such as a ride or ride-share service. Accordingly, various embodiments can also improve a computer system's ability to build a comprehensive database of accurate place data.

For example, an embodiment may be used in conjunction with a place data process pipeline used to process (e.g., ingest, match and combine, filter for relevance, and analyze for accuracy) place records obtained from a data source, such as third-party data source for place data, prior to the place records being used in the comprehensive database. Where place records are sourced from multiple data sources (e.g., third-party providers), a place data process pipeline may comprise matching place records from the different data sources to identify place records that refer to the same physical location, and for each set of match place records, combining the information of the set of matched place records (e.g., by selecting the best latitude and longitude coordinate, best name, and best address) to output a single place record to describe the place originally described by the set of matched place records. The place records may be matched, for instance, based on a place name, a place address, a place type, or geographic coordinates of a place. With respect to the place data process pipeline, an embodiment described herein may be used to filter out from use place records that do not meet or satisfy a set of criteria that determine accuracy or quality of a place record. For instance, such filtering may be performed prior to place records being used by, or deployed for use by, a location-based service, such as a software service operating on a client device. Depending on the embodiment, the filtering out of place records may be performed after place records have been matched and combined. Further, the filtering out of place records (e.g., matched and combined place records) may be performed after such place records have been filtered out based on another criterion, such as a criterion relating to relevance of the place record for its intended use (e.g., use by a ride or ride-sharing service).

As described herein, a place record evaluated for accuracy may be one that is produced by matching and combining multiple place records, from multiple data sources (e.g., third-party providers), that describe the same place. The geographic coordinates provided by such a matched and combined place record may comprise geographic coordinates (for the described place) that are selected from, or predicted based on, the different geographic coordinates provided by the different place records that are matched. In this context, an embodiment described herein may be used to determine the accuracy (e.g., precision) of a method (e.g., algorithm) used to select or predict the geographic coordinates for the matched and combined place record. The precision of the method may be defined by, for example, a percentage of place records that pass a set of criteria used for determining accuracy of place records.

Selection or prediction of geographic coordinates may comprise processing a set of features for a place record, using a machine learning (ML) model (e.g., a decision tree model), to generate a probability that the geographic coordinates provided by the different place records are the best choice for the matched and combined place record.

Various embodiments described herein determine accuracy of a place record using a set of context-based criteria. Though several embodiments described herein do so by determining the accuracy of geographic coordinates provided by the place record, other embodiments may do so by determining accuracy of an additional or alternative feature of the place record using a set of context-based criteria.

Reference will now be made in detail to embodiments of the present disclosure, examples of which are illustrated in the appended drawings. The present disclosure may, however, be embodied in many different forms and should not be construed as being limited to the embodiments set forth herein.

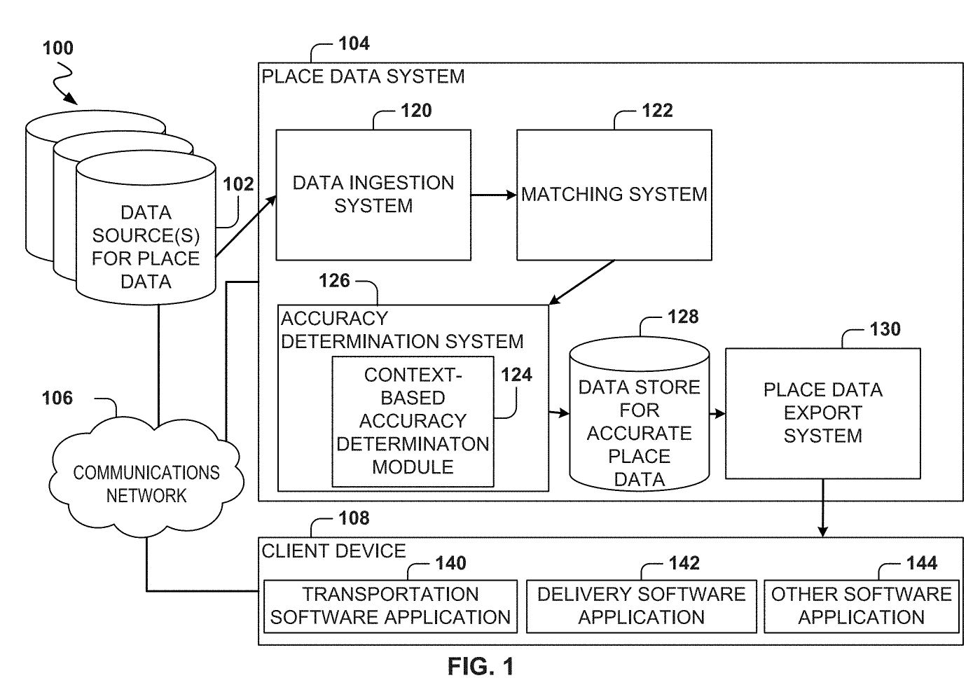

FIG. 1 is a block diagram illustrating an example networked computing environment 100 that includes a place data system 104, according to some embodiments. As shown, the place data system 104 is part of the networked computing environment 100 that includes one or more data sources 102 for place data, a client device 108, and a communications network 106 communicatively coupled to the place data system 104, the data sources 102, and the client device 108 to facilitate communication therebetween. The communications network 106 may comprise one or more local or wide-area communications networks, such as an ad hoc network, an intranet, an extranet, the Internet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, or a Wi-Fi® network. Additionally, though only one client device 108 is illustrated, it will be appreciated that the networked computing environment 100 may include any number of client devices.

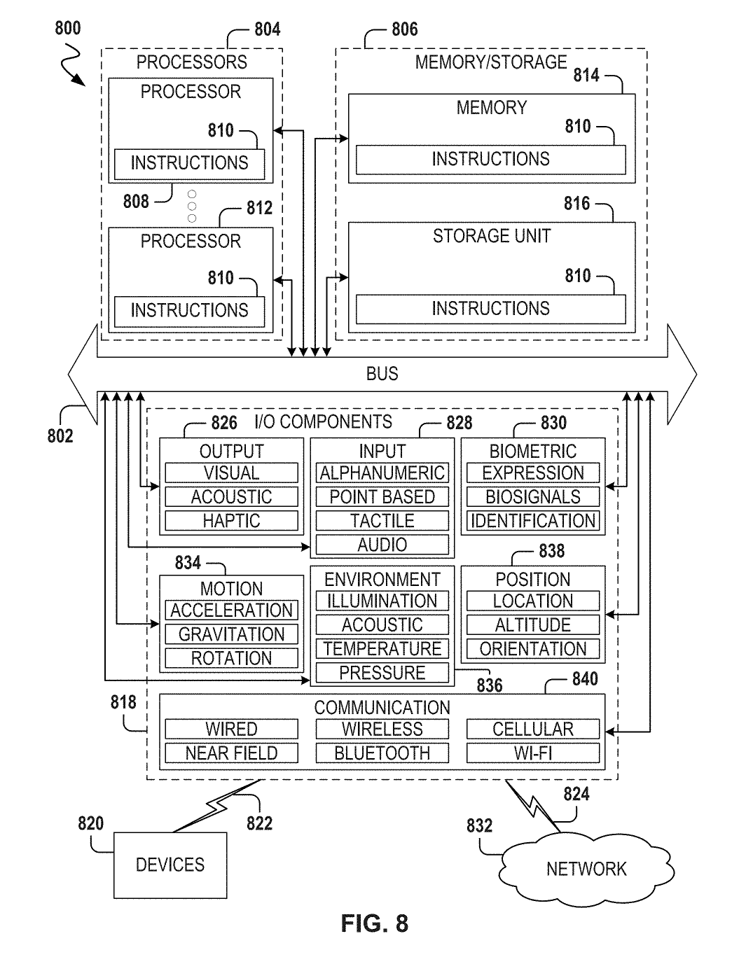

The data sources 102 provide the place data system 104 with place data (e.g., as place records) for determining (e.g., evaluating) accuracy of the place data based on context of the place data. For some embodiments, the data sources 102 are implemented by one or more machines (e.g., networked machines), which may be similar to a machine 800 described herein with respect to FIG. 8. The data sources 102 can include one or more data sources maintained or operated by an entity that is a third party with respect to an entity operating the place data system 104, or an entity intending to use accurate place data (e.g., accurate place records). Additionally, data sources 102 can include one or more data sources that collect and store place data generated or maintained by crowd-sourcing, where a plurality of users (e.g., a user-base) can directly or indirectly input information to be included in the place data. Examples of data sources for crowd-sourced place data can include, without limitation, location discovery services, such those provided by FOURSQUARE, or social network services (e.g., FACEBOOK or TWITTER). One or more of the data sources 102 may comprise one or more datastores. As used herein, a datastore can include any organization of data stored on a data storage device, such as tables, comma-separated values (CSV) files, databases (e.g., SQL or NoSQL-based database systems), or other known organizational data formats. Datastores can include data structures that provide a particular way of storing and organizing data such that the data can be used efficiently within a given context. As noted herein, place data may be maintained as one or more place data records, where each place record can comprise data regarding a single place located on a geographic map.

The place data system 104 comprises a data ingestion system 120, a matching system 122, an accuracy determination system 126, a data store 128 for accurate place data, and a place data export system 130. According to some embodiments, the place data system 104 ingests place data (e.g., in the form of one or more place records) from the data sources 102, determines accuracy of the ingested place data based on contexts, and provides (e.g., exports) accurate place data for use by one or more software applications that provide, support, or otherwise facilitate a service, such as a mapping service, a transport/transportation arrangement service, or a delivery service. For some embodiments, the place data system 104 is implemented by one or more machines (e.g., networked machines), which may be similar to the machine 800 described herein with respect to FIG. 8.

The data ingestion system 120 accesses place data (e.g., place records) from the data sources 102, thereby permitting the place data system 104 to ingest place data from at least one of the data sources 102. The data ingestion system 120 may include one or more data interfaces, such as a database interface, that facilitate access by the data ingestion system 120 to data stored on at least one of the data sources 102.

The matching system 122 receives a plurality of place records and identifies (e.g., matches) place records that refer to the same physical location on a geographic map. In this way, the matching system 122 can determine a set of matched place records that refer to the same physical location on the map. Place records may be matched, for instance, based on one or more attribute values included in place records, such as place names, place addresses, place types, or place geographic coordinates. The plurality of place records received by the matching system 122 may originate from two or more different data sources in the data sources 102. As noted herein, place records accessed by the place data system 104 (e.g., via the data ingestion system 120) can be sourced from multiple data sources (e.g., third-party providers) that are part of the data sources 102. For some embodiments, the matching system 122 combines the information of a set of matched place records that refer to the same physical location on a geographic map and generates a single place record to describe the place corresponding to the physical location and originally described by the set of matched place records. Combining a set of matched place records to generate a single place record may comprise, for instance, selecting the best latitude and longitude coordinates for the place, best name for the place, and the best address for the place.

The accuracy determination system 126 receives a place record and determines an accuracy of the received place record. As shown, the accuracy determination system 126 includes a context-based accuracy determination module 124, which can determine a context for the received place record and determine the accuracy of the received place record based on the determined context for the received place record. In particular, the context-based accuracy determination module 124 can determine the accuracy of the received place record based on a set of criteria associated with the context determined for the received place record. Determining the context for the received place record may comprise generating a set of features for the received place record, and the set of features may be generated by extracting a value (e.g., field value) from an attribute (e.g., field) of the received place record (e.g., making feature value equal to extract value), or deriving a feature based on a value from an attribute of the received place record (e.g., feature value determined based on a calculation performed using the attribute value).

With respect to the received place record describing a particular place, an example context-based criterion can include, without limitation: one relating to a coordinate (e.g., geographic coordinates); one relating to a threshold for a distance between geographic coordinates (e.g., latitude and longitude coordinates) from the received record and ground-truth coordinates (e.g., rooftop centroid, popular pick-up/drop-off location, or building entrance/exit) for the particular place; and one relating to whether a first location, corresponding to geographic coordinates from the received place record, is across a road from a second location corresponding to ground-truth coordinates for the particular place. The place data system 104 can use the accuracy determination system 126 to filter out place records that fail to satisfy the set of criteria.

The data store 128 for accurate place data receives a place record and stores the received place record for subsequent use, such as by a location-based service. For some embodiments, one or more place records received by the data store 128 are those determined to be accurate by the accuracy determination system 124. The place records determined to be accurate and stored on the data store 128 may be those already processed and produced by the matching system 122. In addition to storing a place record, the data store 128 can store a score representing the level of accuracy of the place record.

The place data export system 130 accesses the data store 128 and provides (e.g., exports) one or more place records from the data store 128 to one or more client devices, such as the client device 108. The place data export system 130 may provide a set of place records on demand by a client device (e.g., the client device 108) or push the set of place records to a client device. For instance, the set of place records may be provided to the client device in response to a search request submitted by the client device (e.g., search for a place to eat). For some embodiments, the one or more place records provided to a client device are accurate or sufficiently accurate for use by a software application associated with a service, such as a mapping service, a transportation or transportation arrangement service, a delivery service, or a directory service.

During operation, according to some embodiments, a set of place records flows through the place data system 104 from the data ingestion system 120, to the matching system 122, to the accuracy determination system 126, and to the data store 128. In this way, the set of records can be matched and combined by the matching system 122 prior to being evaluated for accuracy by the accuracy determination system 126.

For some embodiments, the client device 108 comprises one or more machines (e.g., networked machines), which may be similar to the machine 800 described herein with respect to FIG. 8. For instance, the client device 108 comprises a user device, such as a mobile phone, desktop computer, laptop, a portable digital assistant (PDA), smart phone, a tablet, an ultrabook, a netbook, a microprocessor-based or programmable consumer electronic device, a game console, a set-top box, or another communication device that a user may use to access the communications network 106. In some embodiments, the client device 108 comprises a display interface (not shown) to display information (e.g., in the form of user interfaces). In further embodiments, the client device 108 comprises one or more touch screens, accelerometers, gyroscopes, cameras, microphones, global positioning system (GPS) devices, and the like. The client device 108 may be a device of a user that is used to access a location-based service, such as a mapping service, a transportation or transportation arrangement service, a delivery service, or a directory service. A user of the client device 108 may comprise a human individual or a machine.

The client device 108 may include one or more software applications such as, but not limited to, a web browser, a messaging application, an electronic mail (e-mail) application, and the like. As shown, the client device 108 comprises a transportation software application 140, a delivery software application 142, and other software application 144.

The transportation software application 140 provides, supports, or otherwise facilitates a transportation or transportation arrangement service. For instance, in the context of a transportation service, the transportation software application 140 may comprise a software application used by a ride requester (e.g., rider), a ride provider (e.g., a driver), or both (e.g., the software application may have different modes) to facilitate a ride from a pick-up location to a destination. For example, the transportation software application 140 can use accurate place data (e.g., place records), provided by the place data system 104, to enable a ride requester to set a pick-up location or a destination, described by the accurate place data, for a requested ride. The accuracy of geographic coordinates included in place data can ensure that the rider is picked up at location expected by the rider and driver, or that the rider is dropped off at a location expected by the rider and driver.

The delivery software application 142 provides, supports, or otherwise facilitates a delivery service, such as a service for delivering food or a package. For example, in the context of a food delivery service, the delivery software application 142 may comprise a software application used by a food requester (e.g., restaurant patron), a food provider (e.g., a restaurant customer), or both (e.g., the software application may have different modes) to facilitate food delivery. For example, the delivery software application 142 can use accurate place data (e.g., place records), provided by the place data system 104, to enable a restaurant customer to search for a restaurant described by the accurate place data, and submit to that restaurant a request for food delivery to a destination described by the accurate place data.

The other software application 144 represents a software application that can provide, support, or otherwise facilitate another type of service for a user of the client device 108. Another type of service may include a mapping service that provides the user with directions from their current location to a place located on a geographic map using accurate place data provided by the place data system 104. Yet another type of service may include a directory service that provides the user with directory and location information for places on a geographic map using accurate place data provided by the place data system 104.

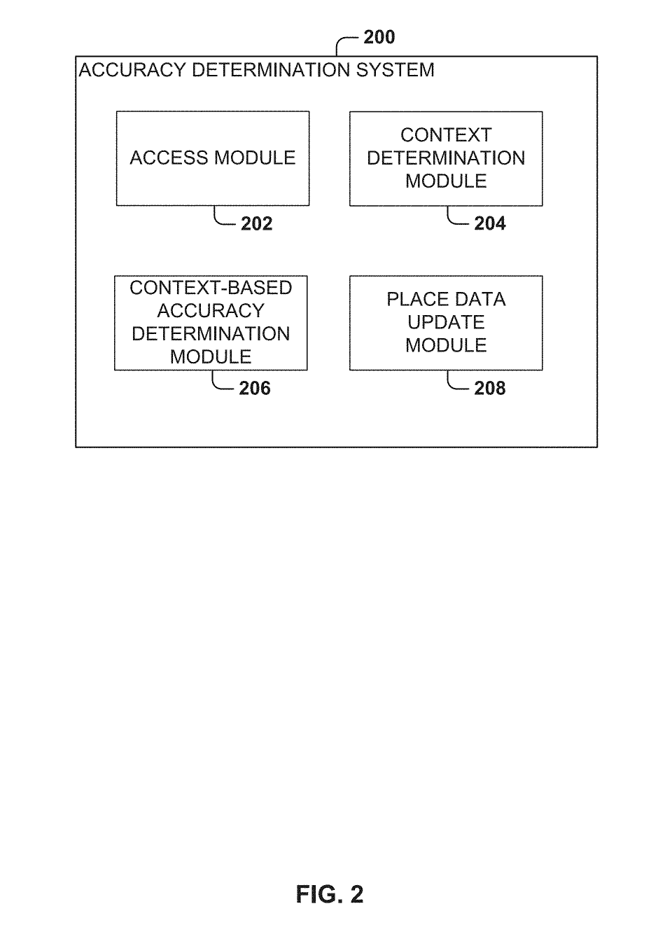

FIG. 2 is a diagram illustrating an example accuracy determination system 200 for determining accuracy of place data, according to some embodiments. For some embodiments, the accuracy determination system 126 described with respect to FIG. 1 comprises the accuracy determination system 200. As shown, the accuracy determination system 200 comprises an access module 202, a context determination module 204, a context-based accuracy determination module 206, and a place data update module 208. Though the accuracy determination system 200 is described and depicted herein as including specific components and details, for some embodiments, the accuracy determination system 200 is practiced according to different details or with more, less, or different components than those shown.

The access module 202 accesses a particular place record for which accuracy (e.g., geographic coordinate accuracy) needs to be determined. In some instances, the particular place record accessed by the access module 202 may be one resulting from a process that matches different place records referring to the same place and combines them into the particular place record. For some embodiments, matching and combining of different place records into the particular place record comprises selecting, for use in the particular place record, particular geographic coordinates from a plurality of geographic coordinates corresponding to the different place records. The selection of the particular geographic coordinates, from the plurality of geographic coordinates, may comprise producing a plurality of probabilities corresponding to the plurality of geographic coordinates by processing each different place record. The probabilities may be produced using a machine-learning (ML) model (e.g., gradient-boosted decision tree model), which may involve generating a set of features for each different place record, and generating a probability for each different place record by processing its set of features using the ML model. The particular geographic coordinates, for the particular place record, may then be selected from the plurality of geographic coordinates based on the plurality of probabilities.

The context determination module 204 determines a context for the particular place record based on at least one value from an attribute included in the particular place record. For some embodiments, the context is determined by generating a set of features for the particular place record, where the set of features may include at least one feature relating to a coordinate (e.g., geographic coordinates provided by the particular place record).

The context-based accuracy determination module 206 determines an accuracy of the particular place record based on a set of criteria associated with the context determined by the context determination module 204. In particular, for some embodiments, the context-based accuracy determination module 206 determines that the particular place record is accurate if the set of criteria are satisfied, and otherwise determines that the particular place record is not accurate. For various embodiments, the accuracy of the geographic coordinates of the particular place record may be determined, by the context-based accuracy determination module 206, based on the set of criteria associated with the context, and the determination of accuracy of those geographic coordinates determines the accuracy (e.g., quality) of the particular place record. As noted herein, accuracy of another attribute (e.g., name, address, category, etc.) of the particular place record based a set of criteria associated with the context determined by the context determination module 204 (e.g., a context not determined by the other attribute).

The place data update module 206 updates a place record based on the accuracy of the particular place record as determined by the context-based accuracy determination module 206. For example, the place data update module 206 may update a place record based on the accuracy of the geographic coordinates of the particular place record as determined by the context-based accuracy determination module 206. For some embodiments, updating the place record based on the determining the accuracy of the particular place record comprises designating the place record as being accurate in response to determining that the geographic coordinates satisfy the set of criteria. Alternatively, updating the place record based on the determining the accuracy of the particular place record may comprise designating the place record not being accurate in response to determining that the geographic coordinates do not satisfy the set of criteria. In this way, some embodiments may cause the place record to be filtered out from use by a service in response to determining that the geographic coordinates do not satisfy the set of criteria.

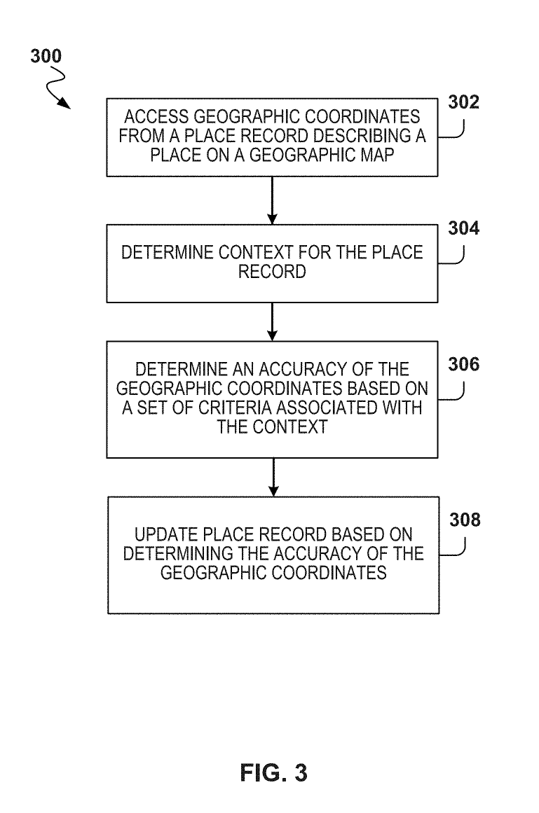

FIGS. 3-5 are flowcharts illustrating example methods for determining accuracy of a place record, according to some embodiments. It will be understood that example methods described herein may be performed by a device, such as a server executing instructions of a transportation or transportation arrangement system. Additionally, example methods described herein may be implemented in the form of executable instructions stored on a computer-readable medium or in the form of electronic circuitry. For instance, the operations of a method 300 of FIG. 3 may be represented by executable instructions that, when executed by a processor of a computing device, cause the computing device to perform the method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to FIG. 3, the flowchart illustrates the example method 300 for determining accuracy of place data, according to some embodiments. In particular, the method 300 may be used to determine the accuracy of one or more place records provided by one or more data sources (e.g., the data sources 102 of FIG. 1). For some embodiments, the method 300 is performed by the place data system 104 described above with respect to FIG. 1. An operation of the method 300 may be performed by one or more hardware processors (e.g., central processing unit or graphics processing unit) of a computing system.

The method 300 as illustrated begins with operation 302 (e.g., the access module 202) accessing particular geographic coordinates from a particular place record, where the particular place record describes a particular place on a geographic map. The particular place record may originate from (e.g., may be stored on) at least one data source. The at least one data source may include (e.g., store) a place record that is generated or maintained by a plurality of human users. For instance, a place record on the at least one data source may be crow-sourced, whereby one or more fields of the place record may be populated or periodically updated by one or more users (e.g., by way of a location search or discovery service, such as one provided by FOURSQUARE). Place data generated or maintained by users may have missing information (e.g., missing geographic coordinates values), include inaccurate information (e.g., inaccurate geographic coordinates), or include fabricated information (e.g., fabricated geographic coordinates).

The method 300 continues with operation 304 (e.g., the context determination module 204) determining a context for the particular place record based on at least one value from an attribute included in the particular place record. For some embodiments, generation of the context for the particular place record comprises generating a set of features for the place record, which may include at least one feature relating to a coordinate, such as geographic coordinates. Generating the set of features for the place record may comprise extracting at least one value from an attribute (e.g., field) of the particular place record, or deriving a feature value based on values from one or more attributes (e.g., fields) of the accessed particular place record.

The method 300 continues with operation 306 (e.g., the context-based accuracy determination module 206) determining an accuracy of the particular geographic coordinates based on a set of criteria associated with the context. The set of criteria may include, without limitation, a criterion relating to a ride or ride-sharing service; a criterion relating to a threshold for a distance between the particular geographic coordinates and ground-truth coordinates (e.g., at rooftop centroid, popular pick-up/drop-off location, or building entrance/exit) for the particular place; a criterion relating to an upper bound for a distance between the particular geographic coordinates and ground-truth coordinates for the particular place; a criterion relating to a lower bound for a distance between the particular geographic coordinates and ground-truth coordinates for the particular place; or a criterion relating to whether the first location corresponding to the geographic coordinates from the particular place record is across a road from the second location corresponding to ground-truth coordinates for the particular place.

For some embodiments, the inclusion of a criterion in the set of criteria depends on the context of the place record. For instance, assume that the context determined for a given place record indicates that the place record describes a large place (e.g., based on a place category indicated by the place record), such as a hospital, airport, shopping mall, park, or campus. Based on this context, the set of criteria may include one or more criteria that relaxes conditions used to evaluate the distance between ground-truth coordinates and place record-provided geographic coordinates when determining the accuracy of the place record-provided geographic coordinates. The set of criteria based on the context may not be the same set of criteria used to determine accuracy of another place record where its context indicates that the other place record describes a small place, such as a residence, a coffee shop, or a convenient store.

The method 300 continues with operation 308 (e.g., the place data update module 208) updating the particular place record based on the accuracy of the geographic coordinates determined by operation 306. As described herein, updating the place record based on the determining the accuracy of the geographic coordinates may comprise designating the place record as being accurate in response to determining that the geographic coordinates satisfy the set of criteria. Alternatively, updating the place record based on the determining the accuracy of the geographic coordinates may comprise designating the place record not being accurate in response to determining that the geographic coordinates do not satisfy the set of criteria. In this way, some embodiments may cause the place record to be filtered out from use by a service in response to determining that the geographic coordinates do not satisfy the set of criteria.

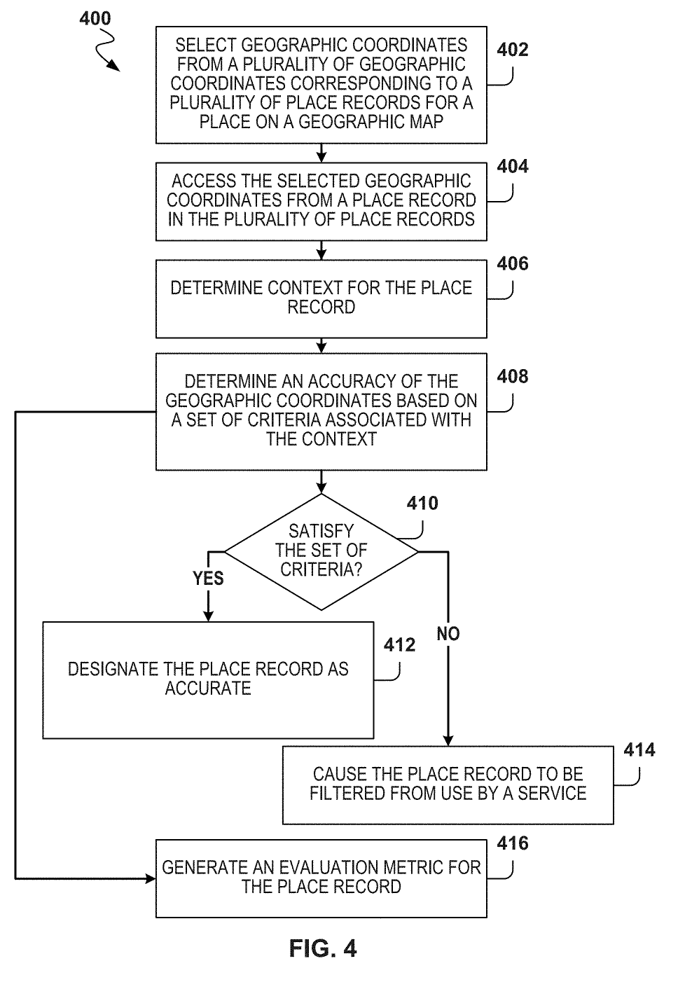

Referring now to FIG. 4, the flowchart illustrates the example method 400 for determining accuracy of place data, according to some embodiments. Like the method 300, the method 400 may be used to determine the accuracy of one or more place records provided by one or more data sources (e.g., the data sources 102 of FIG. 1). Additionally, the method 400 may be performed by the place data system 104 described above with respect to FIG. 1. An operation of the method 400 may be performed by one or more hardware processors of a computing system.

The method 400 as illustrated begins with operation 402 (e.g., the matching system 122) selecting geographic coordinates from a plurality of geographic coordinates corresponding to a plurality of place records for a place on a geographic map. As described herein, this selection of geographic coordinates may be performed during the matching and combining of different place records that refer to the same place.

The method 400 continues with operations 404-408, which, according to some embodiments, are respectively similar to operations 302-306 of the method 300 described above with respect to FIG. 3. After operation 408, the method 400 continues to operation 410, operation 416, or some combination thereof (e.g., continue to operation 416, then operation 410). In response to operation 410 determining that the set of criteria is satisfied, the method 400 continues to operation 412. In response to operation 410 determining that the set of criteria is not satisfied, the method 400 continues to operation 414.

Operation 412 designates the place record as being accurate. A place record designated as accurate may be stored (e.g., on a data store) for subsequent use by a service, such as a software application that facilitates a location-based service (e.g., a ride, ride-sharing, or delivery service). Operation 414 causes the place record to be filtered from use by a service, such as a ride service, a ride-sharing service, or a delivery service. For some embodiments, the place record is filtered from use by not storing the place record to a data store for storing accurate place records (e.g., the data store 128). Operation 416 generates an evaluation metric of the place record based on the determination of accuracy of the geographic coordinates by operation 408. The evaluation metric may comprise an indication of whether the geographic coordinates of the particular place record passes an accuracy determination, and may comprise other quality factors (e.g., values) determined during the evaluation of the particular place record based on the set of context-based criteria.

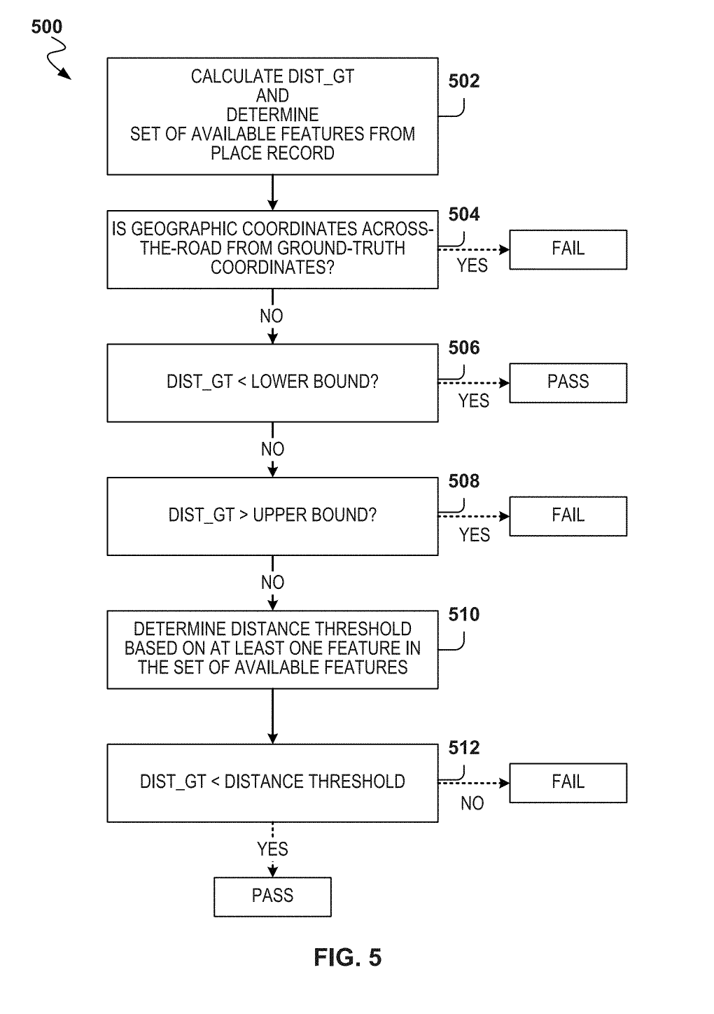

Referring now to FIG. 5, the flowchart illustrates the example method 500 for determining accuracy of place data, according to some embodiments. In particular, the method 500 may be used to determine the accuracy of a place record, based on a set of criteria and the context of the place record, for use with a location-based service, such as a ride service or a ride-sharing service. Like the method 300, the method 500 may be used to determine the accuracy of one or more place records provided by one or more data sources (e.g., the data sources 102 of FIG. 1). Additionally, the method 500 may be performed by the place data system 104 described above with respect to FIG. 1. An operation of the method 500 may be performed by one or more hardware processors of a computing system.

The method 500 as illustrated begins with operation 502 (e.g., the context determination module 204) calculating a distance (dist_gt) between a first location corresponding to geographic coordinates included in a given place record describing a particular place, and a second location corresponding to ground-truth coordinates for the particular place. Operation 502 also determines a set of available features from the given place record. For some embodiments, determining the set of available features comprises determining which attributes are provided by the given place record, determining which of those attributes are of interest to the method 500 (e.g., by comparing it to a predetermined list of attributes of interest), and generating the set of available features based on values from those attributes of interests. Additionally, as described herein, a feature may be generated based on values from a place record's attributes by extracting a value from an attribute (e.g., feature value equals extract attribute value) of the place record or deriving the feature based on the value of the attribute (e.g., feature value is determined based on a calculation performed using the attribute value) of the place record. For some embodiments, the context of the given place record comprises the distance (dist_gt) calculated by operation 502 and the set of available features determined by operation 502.

The method 500 continues with operation 504 (e.g., the context-based accuracy determination module 206) determining whether the geographic coordinates from the given place record and the ground-truth coordinates correspond to locations on a geographic map that are across a road from each other. In response to determining that the corresponding locations are across the road from each other, the method 500 determines that the accuracy of the place record fails. In response to determining that the corresponding locations are not across the road from each other, the method 500 continues to operation 506.

Operation 506 (e.g., the context-based accuracy determination module 206) determines whether the distance dist_gt calculated by operation 502 is less than a lower bound value (e.g., 50 meters). In response to operation 506 determining that the calculated distance dist_gt is less than the lower bound value, the method 500 determines that the accuracy of the place record passes. In response to operation 506 determining that the calculated distance dist_gt is not less than the lower bound value, the method 500 continues to operation 508.

Operation 508 (e.g., the context-based accuracy determination module 206) determines whether the distance dist_gt calculated by operation 502 is greater than an upper bound value (e.g., 200 meters). In response to operation 508 determining that the calculated distance dist_gt is greater than the upper bound value, the method 500 determines that the accuracy of the place record fails. In response to operation 508 determining that the calculated distance dist_gt is not greater than the upper bound value, the method 500 continues to operation 510.

Operation 510 (e.g., the context-based accuracy determination module 206) determines a distance threshold based on at least one feature in the set of available features determined at operation 502. For instance, where a set of desired features is not included in the set of available features, the distance threshold may be set to a default value (e.g., 110 meters). In another instance, where the set of available features includes a median distance (dist_cat) for a place category associated with the place (e.g., a matching median distance calculated from matched map features from third-party providers), the threshold may be determined as follows: distance threshold=−1321+6.450*dist_cat. In another instance, where the set of available features includes the median distance (dist_cat) and an average distance (density) between places in the locality (cell) corresponding to the geographic coordinates of the place record (e.g., density in the S2 cell), the threshold may be determined as follows: distance threshold=−57.830+5.253*dist_cat+1.906*density.

The method 500 continues with operation 512 (e.g., the context-based accuracy determination module 206) determining whether the distance dist_gt calculated by operation 502 is less than the distance threshold determined by operation 510. In response to operation 512 determining that the calculated distance dist_gt is not less than the determined distance threshold, the method 500 determines that the accuracy of the place record fails. In response to operation 512 determining that the calculated distance dist_gt is less than the determined distance threshold, the method 500 determines that the accuracy of the place record passes.

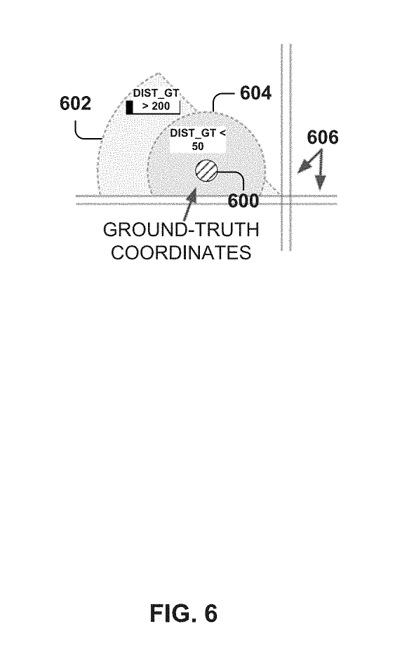

FIG. 6 is a diagram illustrating example criteria for determining accuracy of place data, according to some embodiments. In particular, FIG. 6 illustrates ground-truth coordinates 600 on a geographic map, road geometries 606 on the geographic map, an upper bound 602 (e.g., 200 meters) for a distance between geographic coordinates a place record and the ground-truth coordinates 600, and a lower bound 604 (e.g., 50 meters) for the distance between the geographic coordinates from the place record and the ground-truth coordinates 600. For some embodiments, one or more criteria relating the road geometries 606, the upper bound 602, the lower bound 604, or some combination thereof, are included in a set of criteria for determining accuracy of the place record based on a context determined for the place record.

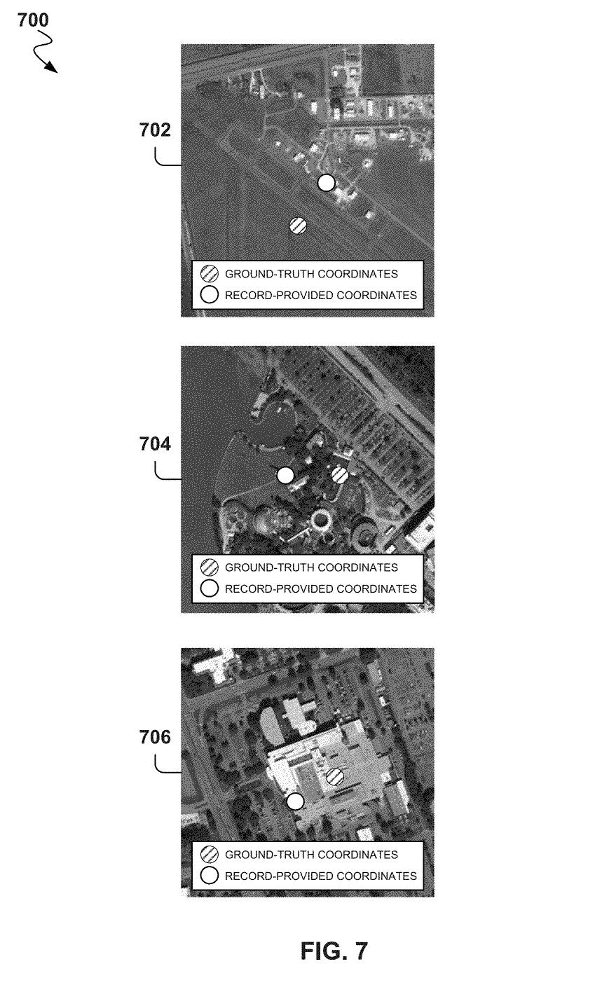

FIG. 7 provides screenshots 702, 704, 706 illustrating example ground-truth and place data-provided coordinates for given places, for which accuracy can be determined according to some embodiments. In particular, each screenshot 702-706 illustrates ground-truth coordinates for a place and geographic coordinates provided by a place record for the same place. According to various embodiments, to determine the accuracy of the place record (or more specifically the geographic accuracy of the geographic coordinates provided by the place record), a context of the place record is determined, and the ground-truth coordinates and the geographic coordinates are evaluated in view of a set of criteria associated with the context. By applying a set of context-based criteria to determine accuracy of place records, such as those applied by the method 500 described above with respect to FIG. 5, accuracy of geographic coordinates provided by a place record can be determined on relaxed criteria when appropriate (e.g., when context of the place record indicates that the place record describes a category of place that is known to be large in geographic area, such as a hospital, airport, shopping mall, park, campus, and the like).

For instance, screenshot 702 comprises a screenshot of an airport, the place record-provided coordinates appear to be located at the airport's parking lot, and the ground-truth coordinates appear to be located at the airport's centroid near a runway. When performing the method 500 of FIG. 5 on the coordinates of screenshot 702, under the assumption that the dist_gt=185.6 meters and distance threshold=200.0 meters, the method 500 determines that the accuracy of the place record passes.

In another instance, screenshot 704 comprises a screenshot of an aquarium park, the place record-provided coordinates appear to be located within the aquarium park, and the ground-truth coordinates appear to be located near the aquarium park's entrance and parking lot. When performing the method 500 of FIG. 5 on the coordinates of screenshot 704, under the assumption that the dist_gt=93.0 meters and distance threshold=126.3 meters, the method 500 determines that the accuracy of the place record passes.

In yet another instance, screenshot 706 comprises a screenshot of a hospital, the place record-provided coordinates appear to be located near the entrance of the hospital, and the ground-truth coordinates appear to be located at the hospital's centroid. When performing the method 500 of FIG. 5 on the coordinates of screenshot 706, under the assumption that the dist_gt=72.1 meters and distance threshold=176.5 meters, the method 500 determines that the accuracy of the place record passes.

FIG. 8 is a block diagram illustrating components of a machine 800, according to some embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. For example, the instructions 810 may cause the machine 800 to execute the flow diagrams of other figures. Additionally, or alternatively, the instructions 810 may implement the servers associated with the services and components of other figures, and so forth. The instructions 810 transform the general, non-programmed machine 800 into a particular machine 800 programmed to carry out the described and illustrated functions in the manner described.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while only a single machine 800 is illustrated, the term “machine” shall also be taken to include a collection of machines 800 that individually or jointly execute the instructions 810 to perform any one or more of the methodologies discussed herein.

The machine 800 may include processors 804, memory/storage 806, and I/O components 818, which may be configured to communicate with each other such as via a bus 802. In an embodiment, the processors 804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 808 and a processor 812 that may execute the instructions 810. The term “processor” is intended to include multi-core processors that may comprise two or more independent processors (sometimes referred to as “cores”) that may execute instructions contemporaneously. Although FIG. 8 shows multiple processors 804, the machine 800 may include a single processor with a single core, a single processor with multiple cores (e.g., a multi-core processor), multiple processors with a single core, multiple processors with multiples cores, or any combination thereof.

The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of the processors 804 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Electrically Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 810. The term “machine-readable medium” shall also be taken to include any medium, or combination of multiple media, that is capable of storing instructions (e.g., instructions 810) for execution by a machine (e.g., machine 800), such that the instructions, when executed by one or more processors of the machine (e.g., processors 804), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 818 may include a wide variety of components to receive input, provide output, produce output, transmit information, exchange information, capture measurements, and so on. The specific I/O components 818 that are included in a particular machine will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion, and the grouping is in no way limiting. In various embodiments, the I/O components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further embodiments, the I/O components 818 may include biometric components 830, motion components 834, environmental components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 may include acceleration sensor components (e.g., accelerometer), gravitation sensor components, rotation sensor components (e.g., gyroscope), and so forth. The environmental components 836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via a coupling 824 and a coupling 822, respectively. For example, the communication components 840 may include a network interface component or other suitable device to interface with the network 832. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a Universal Serial Bus (USB)).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geo-location, location via Wi-Fi® signal triangulation, location via detecting an NFC beacon signal that may indicate a particular location, and so forth.

In various embodiments, one or more portions of the network 832 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 832 or a portion of the network 832 may include a wireless or cellular network and the coupling 824 may be a Code Division Multiple Access (CDMA) connection, a Global System for Mobile communications (GSM) connection, or another type of cellular or wireless coupling. In this example, the coupling 824 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third-Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 810 may be transmitted or received over the network 832 using a transmission medium via a network interface device (e.g., a network interface component included in the communication components 840) and utilizing any one of a number of well-known transfer protocols (e.g., hypertext transfer protocol (HTTP)). Similarly, the instructions 810 may be transmitted or received using a transmission medium via the coupling 822 (e.g., a peer-to-peer coupling) to the devices 820. The term “transmission medium” shall be taken to include any intangible medium that is capable of storing, encoding, or carrying the instructions 810 for execution by the machine 800, and includes digital or analog communications signals or other intangible media to facilitate communication of such software.

According to some embodiments, the method comprises: accessing geographic coordinates from a place record, the place record describing a place on a geographic map; determining a context for the place record based on at least one value from an attribute included in the place record; determining an accuracy of the geographic coordinates based on a set of criteria associated with the context; and updating the place record based on the determining the accuracy of the geographic coordinates. The determining the context may comprise generating a set of features for the place record, the set of features including at least one feature relating to a coordinate.

Updating the place record based on the determining the accuracy of the geographic coordinates may comprise designating the place record as being accurate in response to determining that the geographic coordinates satisfy the set of criteria.

The method may further comprise causing the place record to be filtered out from use by a service in response to determining that the geographic coordinates do not satisfy the set of criteria.

The method may further comprise generating an evaluation metric for the place record based on the determining the accuracy of the geographic coordinates.

The set of criteria may include a criterion relating to at least one of a ride service or a ride-sharing service. The set of criteria may include a criterion relating to an upper bound for a distance between the geographic coordinates and ground-truth coordinates for the place. The set of criteria may include a criterion relating to a lower bound for a distance between the geographic coordinates and ground-truth coordinates for the place.

The set of criteria may include a criterion relating to a threshold for a distance between the geographic coordinates and ground-truth coordinates for the place. The ground-truth coordinates may comprise a rooftop centroid of the place described by the place record. Alternatively, the ground-truth coordinates may comprise coordinates corresponding to a pick-up or drop-off location (e.g., a popular location) with respect to a ride or ride-sharing service, or corresponding to a building entrance or exit location.

The geographic coordinates may correspond to a first location on the geographic map, ground-truth coordinates for the place correspond to a second location on the geographic map, and the set of criteria may include a criterion relating to whether the first location is across a road from the second location.

The method may further comprise, prior to accessing the geographic coordinates, selecting the geographic coordinates from a plurality of geographic coordinates, the plurality of geographic coordinates corresponding to place records that describe the place.

The selecting the geographic coordinates from the plurality of geographic coordinates may comprises; producing a plurality of probabilities corresponding to the plurality of geographic coordinates; and selecting the geographic coordinates from the plurality of geographic coordinates based on the plurality of probabilities. The producing a plurality of probabilities may be achieved by processing each given place record, in a plurality of place records, using a machine learning (ML) model, where the processing of each given place record comprises: generating a set of features for the given place record; and generating a probability, for given geographic coordinates from the given place record, by processing the set of features using the ML model.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

One or more embodiments described herein can be implemented using modules, engines, or components, which may be programmatic in nature. As used herein, a module, engine, or component can comprise a unit of functionality that can be performed in accordance with one or more embodiments described herein. A module, engine, or component might be implemented utilizing any form of hardware, software, or a combination thereof. Accordingly, a module, engine, or component can include a program, a sub-routine, a portion of a software application, or a software component or a hardware component capable of performing one or more stated tasks or functions. For instance, one or more hardware processors, controllers, circuits (e.g., ASICs, PLAs, PALs, CPLDs, FPGAs), logical components, software routines or other mechanisms might be implemented to make up a module, engine, or component. In implementation, the various modules/engines/components described herein might be implemented as discrete elements or the functions and features described can be shared in part, or in total, among one or more elements. Accordingly, various features and functionality described herein may be implemented in any software application and can be implemented in one or more separate or shared modules/engines/components in various combinations and permutations. Even though various features or elements of functionality may be individually described or claimed as separate modules, for some embodiments, these features and functionality can be shared among one or more common software and hardware elements. The description provided herein shall not require or imply that separate hardware or software components are used to implement such features or functionality.

As used herein, the term “or” may be construed in either an inclusive or exclusive sense. The terms “a” or “an” should be read as meaning “at least one”, “one or more”, or the like. The presence of broadening words and phrases such as “one or more”, “at least”, “but not limited to”, or other like phrases in some instances shall not be read to mean that the narrower case is intended or required in instances where such broadening phrases may be absent. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
accessing, by one or more hardware processors, geographic coordinates from a place record, the place record describing a place on a geographic map;
determining, by one or more hardware processors, a context for the place record based on at least one value from an attribute included in the place record;
determining, by one or more hardware processors, an accuracy of the geographic coordinates based on a set of criteria associated with the context; and
updating, by one or more hardware processors, the place record based on the determining the accuracy of the geographic coordinates.

2. The method of claim 1, wherein the determining the context comprises generating a set of features for the place record, the set of features including at least one feature relating to a coordinate.

3. The method of claim 1, wherein the updating the place record based on the determining the accuracy of the geographic coordinates comprises, in response to determining that the geographic coordinates satisfy the set of criteria, designating the place record as being accurate.

4. The method of claim 1, further comprising, in response to determining that the geographic coordinates do not satisfy the set of criteria, causing the place record to be filtered out from use by a service.

5. The method of claim 1, further comprising generating, by one or more hardware processors, an evaluation metric for the place record based on the determining the accuracy of the geographic coordinates.

6. The method of claim 1, wherein the set of criteria includes a criterion relating to at least one of a ride service or a ride-sharing service.

7. The method of claim 1, wherein the set of criteria includes a criterion relating to a threshold for a distance between the geographic coordinates and ground-truth coordinates for the place.

8. The method of claim 7, wherein the ground-truth coordinates comprise a rooftop centroid of the place described by the place record.

9. The method of claim 1, wherein the set of criteria includes a criterion relating to an upper bound for a distance between the geographic coordinates and ground-truth coordinates for the place.

10. The method of claim 1, wherein the set of criteria includes a criterion relating to a lower bound for a distance between the geographic coordinates and ground-truth coordinates for the place.

11. The method of claim 1, wherein the geographic coordinates correspond to a first location on the geographic map, ground-truth coordinates for the place correspond to a second location on the geographic map, and the set of criteria includes a criterion relating to whether the first location is across a road from the second location.

12. The method of claim 1, further comprising, prior to accessing the geographic coordinates, selecting, by one or more hardware processors, the geographic coordinates from a plurality of geographic coordinates, the plurality of geographic coordinates corresponding to place records that describe the place.

13. The method of claim 12, wherein the selecting the geographic coordinates from the plurality of geographic coordinates comprises:
producing a plurality of probabilities corresponding to the plurality of geographic coordinates by processing each given place record, in a plurality of place records, using a machine learning (ML) model, the processing of each given place record comprising:
generating a set of features for the given place record; and
generating a probability, for given geographic coordinates from the given place record, by processing the set of features using the ML model; and
selecting the geographic coordinates from the plurality of geographic coordinates based on the plurality of probabilities.

14. A non-transitory computer storage medium comprising instructions that, when executed by a hardware processor of a device, cause the device to perform operations comprising:
accessing geographic coordinates from a place record, the place record describing a place on a geographic map;
determining a context for the place record based on at least one value from an attribute included in the place record;
determining an accuracy of the geographic coordinates based on a set of criteria associated with the context, and
updating the place record based on the determining the accuracy of the geographic coordinates.

15. The non-transitory computer storage medium of claim 14, wherein the updating the place record based on the determining the accuracy of the geographic coordinates comprises, in response to determining that the geographic coordinates satisfy the set of criteria, designating the place record as being accurate.

16. The non-transitory computer storage medium of claim 14, wherein the operations further comprise, in response to determining that the geographic coordinates do not satisfy the set of criteria, causing the place record to be filtered out from use by a service.

17. The non-transitory computer storage medium of claim 14, wherein the operations further comprise generating an evaluation metric for the place record based on at least the determining the accuracy of the geographic coordinates.

18. The non-transitory computer storage medium of claim 14, wherein the operations further comprise, prior to accessing the geographic coordinates, selecting the geographic coordinates from a plurality of geographic coordinates, the plurality of geographic coordinates corresponding to place records that describe the place.

19. The non-transitory computer storage medium of claim 18, wherein the selecting the geographic coordinates from the plurality of geographic coordinates comprises:
producing a plurality of probabilities corresponding to the plurality of geographic coordinates by processing each given place record, in a plurality of place records, using a machine learning (ML) model, the processing of each given place record comprising:
generating a set of features for the given place record; and
generating a probability, for given geographic coordinates from the given place record, by processing the set of features using the ML model; and
selecting the geographic coordinates from the plurality of geographic coordinates based on the plurality of probabilities.

20. A computer comprising:
a memory storing instructions; and
one or more hardware processors configured by the instructions to perform operations comprising:
accessing geographic coordinates from a place record, the place record describing a place on a geographic map;
determining a context for the place record based on at least one value from an attribute included in the place record; and
determining an accuracy of the geographic coordinates based on a set of criteria associated with the context.
